(19) United States
(12) Patent Application Publication
(10) Pub. No.: US 2007/0131800 A1
(43) Pub. Date: Jun. 14, 2007

(54) Fuel injector with direct needle control

(75) Inventor: Friedrich Boecking, Stuttgart (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: ROBERT BOSCH GMBH, Stuttgart (DE)

(21) Appl. No.: 10/578,907

(22) PCT Filed: Sep. 7, 2004
(86) PCT No.: PCT/DE04/01982

§ 371 Date: May 12, 2006

(30) Foreign Application Priority Data
Nov. 12, 2003 (DE) 103 52 736.2

(51) Int. Cl. F02M 63/00

(52) U.S. Cl. 239/533.2

(57) ABSTRACT

The invention relates to a fuel injector for internal combustion engines, having a high-pressure fuel reservoir, which includes a pressure booster and an injection valve member that has at least one booster portion and one needle portion that closes at least one injection opening. The pressure booster is received in a booster housing and is braced on a spring element which surrounds the booster housing. As a result, the booster housing is fixed on a nozzle housing part that encloses the injection valve member.

### FIELD OF THE INVENTION

For supplying the combustion chambers of internal combustion engines with fuel, fuel injectors are used. Particularly in self-igniting internal combustion engines, the injection pressure is furnished via a high-pressure reservoir. Because of the large fuel volume in the high-pressure reservoir, compared to the injection quantity, pressure fluctuations during the injection event are avoided. The operation of the fuel injectors is effected hydraulically with the fuel furnished via the high-pressure reservoir.

### BACKGROUND OF THE INVENTION

Fuel injectors of the kind used in the prior art for high-pressure reservoir systems are known for instance from Mollenhauer, Handbuch Dieselmotoren [Diesel Engine Manual], 2nd Ed., Springer Verlag, Berlin, 2002. In fuel injectors for high-pressure reservoir systems, both the opening and the closing events are controlled hydraulically. To that end, a control chamber, in which fuel is located at injection pressure, is closed by a control valve. The fuel pressure acts on the backside of a control piston that acts into the control chamber, and on a pressure shoulder of an injection valve member that closes injection openings. The hydraulic force on the backside of the control piston is counter to the hydraulic force that acts on the pressure shoulder. Because of the larger area of the control piston, the nozzle remains closed. As soon as the control valve opens the control chamber, the pressure in the control chamber is diminished, and the hydraulic force on the pressure shoulder becomes greater than the pressure force acting on the backside of the control piston. As a result, the injection valve member opens.

In the fuel injectors known from the prior art, the fuel supply to both the control chamber and a pressure chamber, from which the fuel reaches the combustion chamber via injection openings, is effected via supply lines in the injector housing. In addition, the fuel injectors known from the prior art, with an injection valve member, control piston and control valve, have a complex structure. It is moreover necessary, in the fuel injectors known from the prior art, to manufacture fuel lines in the housing.

### SUMMARY OF THE INVENTION

A fuel injector, embodied according to the invention, for internal combustion engines with a high-pressure fuel reservoir includes a pressure booster and an injection valve member. The injection valve member is preferably divided into a booster portion, a guide portion, and a needle portion, and the needle portion of the injection valve member closes at least one injection opening or opens it for injection of fuel into a combustion chamber of the engine. The pressure booster of the fuel injector is received in a booster housing and is braced on a spring element that surrounds the booster housing. With its other side, the spring element is braced on a step embodied on the booster housing, and as a result the booster housing is fixed on a nozzle housing part enclosing the injection valve member. Suitable spring elements are in particular tube springs, but spiral springs or other annularly embodied spring elements may also be used.

The pressure booster, the booster housing, and an actuator used for actuating the fuel injector are enclosed by an injector housing part, which is connected to the nozzle housing part preferably nonpositively by means of a nozzle lock nut.

The actuator used for triggering the fuel injector is preferably a piezoelectric actuator. Besides the piezoelectric actuator, however, electromagnets or hydraulic/mechanical actuators may also be used.

The booster portion of the injection valve member is enclosed by a sleeve, in which the injection valve member is guided. A bite edge is embodied on a face end of the sleeve oriented toward the booster housing. By means of a spring element that acts on a face end of the sleeve diametrically opposite the bite edge, the bite edge of the sleeve is pressed against the shoulder of the booster housing. This creates a pressure-tight and hence fluid-tight connection. The other side of the spring element that surrounds the booster portion of the injection valve member is braced on a ring, which is located in a plunge cut between the booster portion and the guide portion of the injection valve member.

A rotationally symmetrical booster chamber is enclosed by the sleeve and the shoulder of the booster housing and is defined on its side toward the actuator by a lower end face of the pressure booster and on its side oriented toward the at least one injection opening of the fuel injector by an end face of the booster region of the injection valve member.

The operation of the fuel injector is effected hydraulically, with fuel at system pressure. The system pressure is preferably in the range of from 1300 to 1600 bar.

The fuel at system pressure flows out of the high-pressure fuel reservoir via a fuel supply line into an annular chamber surrounding the actuator. From the annular chamber, the fuel flows through a gap between the pressure booster and the inner wall of the injector housing part into a first spring chamber surrounding the booster housing. From there, the fuel flows via at least one groove in the step of the booster housing, on which the spring element is braced, and which acts as a guide of the booster housing in the injector housing part, into a second spring chamber via grooves in the nozzle housing part and an annular gap between the inner wall of the nozzle housing part and the outer wall of the sleeve. From the second spring chamber, the fuel flows along a ground and polished surface in the guide portion of the injection valve member into a pressure chamber surrounding the needle portion of the injection valve member. As a result, the annular chamber, the first spring chamber, the second spring chamber, and the pressure chamber are all filled with fuel that is at system pressure.

The filling of the booster chamber is preferably effected by reference leakage between the inside face of the sleeve and the booster portion of the injection valve member or by reference leakage between the booster housing and the pressure booster. For the operation of the fuel injector, it is necessary that the pressure in the booster chamber vary. As a result, the pressure in the booster chamber can differ from the system pressure and can thus also differ from the pressure in the annular gap surrounding the booster chamber. It is therefore necessary that the connection between the sleeve and the shoulder in the booster housing, formed by the biting edge at the sleeve, be pressure-tight.

For closing the at least one injection opening by the needle portion of the injection valve member, current is supplied to the piezoelectric actuator. As a result, the crystals in the piezoelectric actuator expand, and the piezoelectric actuator increases in length. The piezoelectric actuator acts directly on an upper end face of the pressure booster, causing the pressure booster, when current is supplied to the piezoelectric actuator, to move into the booster chamber. As a result, the volume of the booster chamber decreases, and the pressure in the booster chamber increases. Because of the increasing pressure in the booster chamber, the hydraulic force that acts on the end face of the booster portion of the injection valve member increases. As a result, the injection valve member is moved in the direction of the at least one injection opening and closes it. The spring element surrounding the booster portion of the injection valve member acts in a reinforcing way in the closing event.

For opening the at least one injection opening, the supply of current to the piezoelectric actuator is cancelled. As a result, the piezoelectric crystals and the piezoelectric actuator contract. As a result, the pressure booster moves out of the booster chamber, whose volume therefore increases. The spring element surrounding the booster housing and braced on a step on the pressure booster acts to reinforce the motion of the pressure booster.

Because of the increasing volume in the booster chamber, the pressure in the booster chamber decreases. As a result, the hydraulic force acting on the end face of the booster portion of the injection valve member is reduced as well, a hydraulic force that is oriented counter to the hydraulic force that acts on the end face of the booster portion of the injection valve member is exerted on pressure steps on the injection valve member. As soon as the force acting on the pressure steps is greater than the hydraulic force on the end face of the booster portion and the spring force of the spring element surrounding the booster portion, the needle portion of the injection valve member lifts from its sealing seat and thus uncovers the at least one injection opening.

For closing the at least one injection opening again, current is supplied to the piezoelectric actuator again, causing the piezoelectric crystals to expand and the piezoelectric actuator to lengthen. As a result, the pressure booster is moved into the booster chamber again, causing the volume of the booster chamber to decrease and the pressure in it to increase. Because of the increasing pressure in the booster chamber, the hydraulic force on the end face of the booster portion of the injection valve member increases. As soon as that force is greater than the hydraulic force acting in the opposite direction on the pressure steps of the injection valve member, the needle portion of the injection valve member is put back into its sealing seat and thus closes the at least one injection opening.

### DRAWING

The invention is described in further detail below in conjunction with a drawing.

The sole drawing figure shows a section through a fuel injector embodied according to the invention.

### VARIANT EMBODIMENTS

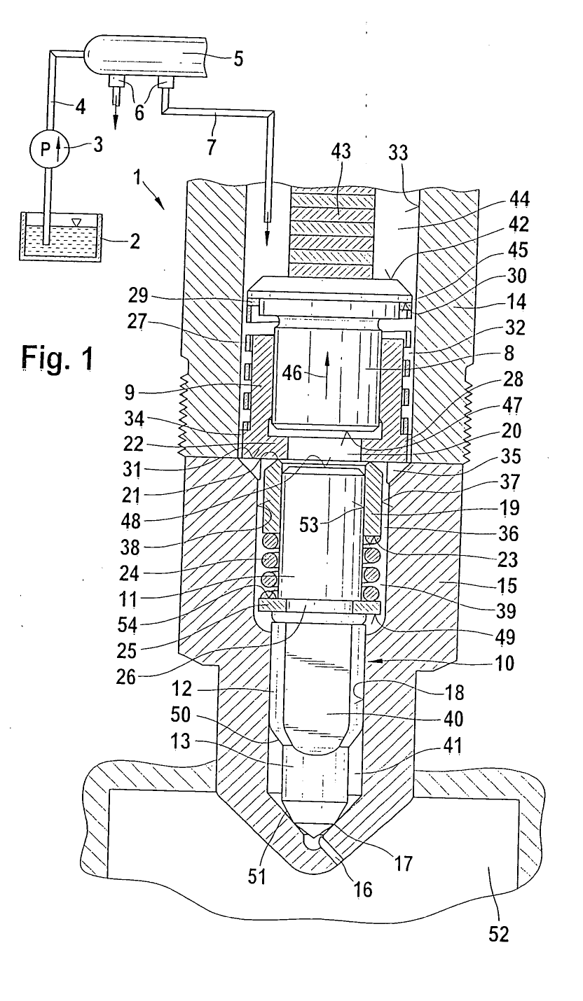

In FIG. 1, a fuel injector embodied according to the invention is shown.

In a fuel injector 1 embodied according to the invention, fuel from a fuel tank 2 first flows into a high-pressure fuel reservoir 5, by means of a high-pressure pump 3 via a high-pressure line 4. Connections 6, corresponding in number to the cylinders of the engine, are located on the high-pressure fuel reservoir 5. Each of the connections 6 communicates via a fuel supply line 7 with a fuel injector 1 embodied according to the invention. The fuel injector 1 includes a pressure booster 8, embodied as a booster piston, which is guided in a booster housing 9, and also includes an injection valve member 10. The injection valve member 10, in a preferred embodiment of the fuel injector 1, is graduated into a booster portion 11, a guide portion 12, and a needle portion 13.

The pressure booster 8, the booster housing 9, and the injection valve member 10 are received in a housing. In a preferred embodiment, the housing is divided into an injector housing part 14 and a nozzle housing part 15. A connection of the injector housing part 14 and the nozzle housing part 15 is preferably effected nonpositively by means of a nozzle lock nut, not shown here.

The fuel injector 1 further includes an injection opening 16, which can be closed by the needle portion 13 of the injection valve member 10. For closing the injection opening 16, the needle portion 13 of the injection valve member 10 is placed against a sealing edge 17, located above the injection opening 16. An exclusively axial motion for opening and closing the at least one injection opening 16 is assured by the provision that the injection valve member 10 is guided with its guide portion 12 in a needle guide 18 located in the nozzle housing part 15. In addition, the booster portion 11 of the injection valve member 10 is enclosed by a sleeve 19, which likewise acts as a needle guide. The sleeve 19 moreover serves as a lateral boundary of a booster chamber 20. To that end, the sleeve 19 is provided with a bite edge 21, which is pressed against a shoulder 22 of the booster housing 9. As a result, a fluid- and hence pressure-tight connection of the sleeve 19 to the shoulder 22 of the booster housing 9 is achieved.

A spring element 24 is braced on an end face 23 of the sleeve 19 diametrically opposite the bite edge 21. The spring element 24 is embodied annularly and encloses the booster portion 11 of the injection valve member 10. Spiral springs, tube springs, or other annularly embodied spring elements known to one skilled in the art are suitable examples as spring elements 24. With its other side, the spring element 24 is braced against a ring 25, which is preferably located in a plunge cut 26 that is located between the booster portion 11 and the guide portion 12 of the injection valve member 10.

The booster housing 9 is surrounded by a second spring element 27, which is braced with one side on a step 28 on the booster housing 9 and with its other side on a ring 29, which rests on a step 30 of the pressure booster 8. The step 28 then simultaneously serves as a guide of the booster housing 9 in the injector housing part 14. The booster housing 9 is fixed on a shoulder 31 on the nozzle housing part 15 by the spring force brought to bear by the spring element 27. The spring element 27 is received in a first spring chamber 32, which is located between the booster housing 9 and the inner wall 33 of the injector housing part 14. At least one groove 34, which is preferably oriented axially, is received in the step 28 of the booster housing 9. Via the at least one groove 34, grooves 35 that are embodied in the shoulder 31 of the nozzle housing part 15, and an at least one annular gap 36, which is embodied between the outer wall 37 of the sleeve 19 and the inner wall 38 of the nozzle housing part 15, the first spring chamber 32 is in hydraulic communication with a second spring chamber 39 surrounding the booster portion 11 of the injection valve member 10. To that end, the at least one groove 34 and the grooves 35 in the shoulder 31 of the nozzle housing part 15 are preferably oriented such that their positions match both radially and axially. The second spring chamber 39 is in hydraulic communication with a pressure chamber 41 via at least one conduit, which is embodied between at least one ground and polished surface 40 in the guide portion 12 of the injection valve member 10 and the needle guide 18.

The control of the fuel injector 1 is effected via an actuator that acts on an upper end face 42 of the pressure booster 8. A piezoelectric actuator 43 is preferably used as the actuator. However, electromagnets or hydraulic/mechanical actuators are also suitable.

The operation of the fuel injector 1 is effected hydraulically with fuel that is at system pressure. The fuel is furnished by the high-pressure fuel reservoir 5. Via the fuel supply line 7, the fuel flows into an annular chamber 44 that surrounds the piezoelectric actuator 43. Via a gap 45 between the pressure booster 8 and the inner wall 33 of the injector housing part 14, the fuel, which is at system pressure, reaches the first spring chamber 32. Via the at least one groove 34, the grooves 35 in the shoulder 31 of the nozzle housing part 15, and the annular gap 36, the fuel flows into the second spring chamber 39. From there, along the at least one ground and polished surface 40, the fuel reaches the nozzle chamber 41. Because of the hydraulic connections among the annular chamber 44, the first spring chamber 32, the second spring chamber 39, and the pressure chamber 41, system pressure prevails both in the annular chamber 44 and in the first spring chamber 32, second spring chamber 39, and pressure chamber 41. The system pressure is preferably in the range from 1300 to 1600 bar.

Because of the large fuel volume, in comparison to the injection quantity, in the high-pressure fuel reservoir 5, the pressure in the annular chamber 44, first spring chamber 32, second spring chamber 39, and pressure chamber 41 remains constant even during operation of the fuel injector 1.

For closing the at least one injection opening 16, current is supplied to the piezoelectric actuator 43. As a result, the piezoelectric crystals in the piezoelectric actuator 43 expand, and the piezoelectric actuator 43 lengthens. Because the piezoelectric actuator 43 acts directly on the upper end face 42 of the pressure booster 8, the pressure booster 8 is moved with a lower face end 47 into the booster chamber 20, counter to the direction of motion indicated by the arrow 46. As a result, the volume in the booster chamber 20 decreases, causing the pressure in it to increase. As a result, the hydraulic force that acts on an end face 48 of the booster portion 11 of the injection valve member 10 increases. The hydraulic force acting on the end face 48 is oriented counter to a hydraulic force acting on a first pressure step 49 on the ring 25, on a second pressure step 50 between the guide portion 12 and the needle portion 13 of the injection valve member 10, and on a third pressure step 51 in the needle portion 13 of the injection valve member 10. As soon as the hydraulic force acting on the end face 48 is greater than the hydraulic force acting on the first pressure step 49, second pressure step 50, and third pressure step 51, the injection valve member 10 is placed against the sealing edge 17 and thus closes the at least one injection opening 16 to a combustion chamber 52 of the engine. The closure of the at least one injection opening 16 is reinforced by the spring force of the spring element 24. For that purpose, the spring element 24 acts on an end face 54 of the ring 25 that is diametrically opposite the first pressure step 49.

For injecting fuel into the combustion chamber 52 of the engine, the current supply to the piezoelectric actuator 43 is cancelled. As a result, the piezoelectric crystals contract and the piezoelectric actuator 43 shrinks. Reinforced by the spring force exerted by the spring element 27, the pressure booster 8 moves in the direction of motion marked by the arrow 46. As a result, the lower end face 47 of the pressure booster 8 moves out of the booster chamber 20, causing its volume to increase. Because of the increasing volume of the booster chamber 20, the pressure in the booster chamber 20 decreases. Since the pressure in the booster chamber 20 drops below the system pressure in this case, it is necessary that the connection between the sleeve 19 and the shoulder 22 in the booster housing 9 be pressure-tight. The filling of the booster chamber 20 is effected by reference leakage between the booster housing 9 and the pressure booster 8, and between the inside 43 of the sleeve 19 and the booster portion 11 of the injection valve member 10.

Because of the decreasing pressure in the booster chamber 20 when current is not being supplied to the piezoelectric actuator 43, the hydraulic force acting on the end face 38 of the booster portion 11 of the injection valve member 10 drops. As soon as the hydraulic force acting on the first pressure step 49, second pressure step 50 and third pressure step 51 is greater than the hydraulic force on the end face 38 and the spring force of the spring element 34, the injection valve member 10 lifts out of the sealing edge 17 and thus uncovers the at least one injection opening 16. Fuel now flows out of the pressure chamber 41 into the combustion chamber 52, via the injection opening 16.

For closing the at least one injection opening 16, current is supplied again to the piezoelectric actuator 43. The piezoelectric crystals expand as a result, and the piezoelectric actuator 43 lengthens. As a result, the pressure booster 8 again moves into the booster chamber 20, counter to the direction of motion indicated by the arrow 46, causing the volume of the booster chamber 20 to decrease. This in turn causes the pressure in the booster chamber 20 to increase and with it the hydraulic force acting on the end face 43 of the booster portion 11 of the injection valve member 10. At the same time, the hydraulic force acting on the first pressure step 49, second pressure step 50, and third pressure step 51 remains constant, since the second spring chamber 39 and the pressure chamber 41 are acted upon by the system pressure, which remains constant. As soon as the spring force of the spring element 24 acting on the ring 25 and the hydraulic force that acts on the end face 48 of the booster portion 11 of the injection valve member 10 is greater than the hydraulic force acting on the first pressure step 49, second pressure step 50, and third pressure step 51, the injection valve member 10 moves in the direction of the at least one injection opening 16 and is pressed against the sealing edge 17. As a result, the at least one injection opening 16 is closed, and the injection event into the combustion chamber 52 is ended.

List of Reference Numerals

1 Fuel injector
2 Fuel tank
3 High-pressure pump
4 High-pressure line
5 High-pressure fuel reservoir
6 Connection
7 Fuel supply line
8 Pressure booster
9 Booster housing
10 Injection valve member
11 Booster portion
12 Guide portion
13 Needle portion
14 Injector housing part
15 Nozzle housing part
16 Injection opening
17 Sealing edge
18 Needle guide
19 Sleeve
20 Booster chamber
21 Bite edge
22 Shoulder
23 End face of sleeve 19
24 Spring element
25 Ring
26 Plunge cut
27 Spring element
28 Step on booster housing 9
29 Ring
30 Step on pressure booster 8
31 Shoulder on nozzle housing part 15
32 First spring chamber
33 Inner wall of injector housing part 14
34 Groove
35 Groove in shoulder 31 on nozzle housing part 15
36 annular gap
37 Outer wall of sleeve 19
38 Inner wall of nozzle housing part 15
39 Second spring chamber
40 ground and polished surface
41 pressure chamber
42 Upper end face
43 piezoelectric actuator
44 annular chamber
45 Gap
46 direction of motion of the pressure booster 8
47 Lower end face
48 End face at booster region 11
49 First pressure step
50 Second pressure step
51 Third pressure step
52 combustion chamber
53 Inside of sleeve 19
54 End face of ring 25

1-15. (canceled)

16. In a fuel injector for internal combustion engines, having a high-pressure fuel reservoir, which fuel injector includes a pressure booster and an injection valve member that has at least one booster portion and one needle portion that closes at least one injection opening, the improvement wherein the pressure booster is received in a booster housing and is braced on a spring element which surrounds the booster housing, as a result of which the booster housing is fixed on a nozzle housing part that encloses the injection valve member.

17. The fuel injector according to claim 16, wherein the booster housing is enclosed by an injector housing part.

18. The fuel injector according to claim 16, wherein the fuel injector is triggered by a piezoelectric actuator.

19. The fuel injector according to claim 17, wherein the fuel injector is triggered by a piezoelectric actuator.

20. The fuel injector according to claim 18, wherein the piezoelectric actuator acts directly on an upper end face of the pressure booster.

21. The fuel injector according to claim 19, wherein the piezoelectric actuator acts directly on an upper end face of the pressure booster.

22. The fuel injector according to claim 16, wherein the booster portion of the injection valve member is enclosed by a sleeve.

23. The fuel injector according to claim 17, wherein the booster portion of the injection valve member is enclosed by a sleeve.

24. The fuel injector according to claim 18, wherein the booster portion of the injection valve member is enclosed by a sleeve.

25. The fuel injector according to claim 20, wherein the booster portion of the injection valve member is enclosed by a sleeve.

26. The fuel injector according to claim 22, wherein the sleeve laterally defines and seals off a booster chamber.

27. The fuel injector according to claim 26, wherein the booster chamber is defined on two diametrically opposite sides by a lower end face of the pressure booster and by an end face of the booster portion of the injection valve member.

28. The fuel injector according to claim 26, wherein the sleeve comprises a bite edge, which is pressed, by means of a spring element surrounding the booster portion of the injection valve member, against a shoulder of the booster housing and thus forms a pressure-tight lateral boundary of the booster chamber.

29. The fuel injector according to claim 16, wherein the injection valve member includes a guide portion having at least one ground and polished surface.

30. The fuel injector according to claim 29, wherein the guide portion of the injection valve member is guided in a needle guide in the nozzle housing part.

31. The fuel injector according to claim 16, wherein the booster housing is guided with a step in the injector housing part.

32. The fuel injector according to claim 16, further comprising a first spring chamber, surrounding the booster housing, and a second spring chamber, surrounding the booster portion of the injection valve member, the spring chambers and communicating hydraulically with one another through at least one groove in the step, an annular gap, and grooves in the nozzle housing part.

33. The fuel injector according to claim 32, further comprising a pressure chamber surrounding the needle portion of the injection valve member, the pressure chamber and the second spring chamber surrounding the booster portion of the injection valve member communicating hydraulically with one another by means of the at least one ground and polished surface in the guide portion of the injection valve member.

34. The fuel injector according to claim 32, wherein system pressure prevails in the first spring chamber, in the second spring chamber, and in the pressure chamber.

35. The fuel injector according to claim 26, wherein the booster chamber is supplied with fuel by reference leakage between the sleeve and the booster portion of the injection valve member, and between the booster housing and the pressure booster.
